(19) United States
(12) Patent Application Publication
(10) Pub. No.: US 2017/0099023 A1
(43) Pub. Date: Apr. 6, 2017

(54) FIELD CONTROL FOR PERMANENT MAGNET DC MOTORS

(71) Applicant: Robert G. Attarian, Mesa, AZ (US)

(72) Inventor: Robert G. Attarian, Mesa, AZ (US)

(21) Appl. No.: 15/314,176

(22) PCT Filed: May 28, 2015
(86) PCT No.: PCT/US2015/032975

§ 371 Date: Nov. 28, 2016

Related U.S. Application Data
(60) Provisional application No. 62/004,553, filed on May 29, 2014.

(51) Int. Cl. H02P 23/00; H02P 6/08

(52) U.S. Cl. CPC H02P 23/0077; H02P 6/085

(57) ABSTRACT

A field control for permanent magnet motors is provided with a memory lookup table containing several addresses corresponding to each coil of the motor. Each address corresponds to the value of current to be supplied to the corresponding coil at the moment that the address location is interrogated. The address to be addressed is modified by a phase shifter to alter the value of the current to be supplied to the corresponding coil. The phase shifter modifies the address being accessed to thereby access an address representing a greater or lesser value of the current being supplied to the corresponding coil. The modification of the address being accessed results in the modification of the current being supplied to the corresponding coil to minimize the total current being supplied to the motor under the given RPM and load conditions.

### RELATED APPLICATIONS

This application is related to and claims priority to a provisional application entitled “FIELD CONTROL FOR PERMANENT MAGNET DC MOTORS” filed May 29, 2014, and assigned Ser. No. 62/004,553.

### FIELD OF THE INVENTION

The present invention relates to motor controls, are more particularly, to controls for permanent magnet DC motors.

### BACKGROUND OF THE INVENTION

A typical permanent magnet DC (PMDC) motor incorporates a given number of permanent magnets secured to a rotor that is rotationally supported within a stator having a plurality of stator windings. As current is supplied to the windings, and varied in a predetermined manner, the electromagnetic fields created by the respective windings interact with the magnetic polarity of the magnets in the rotor to produce a force creating torque and thus cause the rotation of the rotor. The speed of the motor may be controlled by detecting the rotor's rotational velocity in a feedback loop to increase or decrease the current delivered to the stator windings to provide sufficient electromagnetic force to drive the rotor at its rated speed. As a load is imposed on the rotor, the subsequent reduction in rotational velocity is detected by the feedback loop to result in an increase of current delivered to the stator windings to thus increase the speed and resume its rotation of velocity at its rated RPM.

### SUMMARY OF THE INVENTION

The present invention is directed to improving the efficiency of such permanent magnet DC motors. The present invention is directed to the recognition of the creation and collapse of electromagnetic fields caused by the excitation of the stator windings and the super-positioning of the adjacent electromagnetic fields of adjacent stator windings. The electromagnetic fields resulting from the excitation of the coils or windings are modified to interact with adjacent electromagnetic fields from adjacent coils to create a maximum torque on the motor rotor for any given RPM. The modification of the current applied to the respective windings is achieved through the utilization of a memory lookup table having a plurality of addresses assigned to each winding which may be sequentially addressed to provide a signal to a current modulator to supply current to the respective coil or winding at any particular moment or rotational position.

In a traditional permanent magnet DC motor, there is a theoretical sync position when a magnetic pole of the rotor is directly opposite a stator winding (this is the position the rotor would assume if a non-varying DC current is applied to the opposed winding). The current supplied to the winding is switched (reversed) causing the fields to reverse and generate a force on the rotor magnets resulting in rotation of the rotor.

When the electromagnetic fields of adjacent coils or windings are superposed, there is an angular location where the superposed fields of the adjacent coils exert the maximum force on a permanent magnet of the rotor positioned in those fields. This location is not the theoretical sync position, but is offset by an angular value (offset angle) that depends on several electrical/mechanical parameters believed to include the delay caused by impedance of the winding in establishing maximum field strength after switching the current to the winding. The offset angle has been found to be unique to each PMDC motor and remains constant for that motor under any load at a given RPM. If the current being supplied to the windings is controlled to create this chosen offset angle, maximum force (and thus torque) is produced for any given RPM. In a linear equivalent of the rotating rotor, wherein imbedded magnets are imbedded in a linearly moving armature, the same principals apply. That is, the overlapping or superposed electromagnetic fields react with opposing moveable magnets. There is a location wherein the superposed fields exert the maximum force on a permanent magnet positioned in that field. Thus, the increased efficiency resulting from the use of the present invention is applicable not only to permanent magnet DC motors, but also to their linear equivalent wherein a linearly moving armature is driven by switched DC current in adjacent coils.

Adjusting the instantaneous electromagnetic field strength of adjacent coils permits the adjustment of the offset angle at which maximum force is applied to the rotor. By adjusting these field strengths, that angular position at which the maximum force is derived can be determined. This angle, the offset angle, represents the angular position at which the maximum force is applied to the rotor at a given RPM and therefore maximum torque is derived therefrom; further, this angular position developing a maximum torque is unique to each specific motor and will remain as the optimum offset angle for that motor at a specified RPM. As the RPM of the motor is increased, usually by increasing the total current delivered to the motor, the offset angle will change. In a preferred embodiment, an adaptive control continuously monitors the motor total current to continuously select the offset angle to provide the maximum torque for that motor at a given RPM. The addition of a load to the motor will not affect the offset angle; rather, the typical motor speed control will sense the additional load and compensate by increasing total current supplied to the motor to thus maintain the rated RPM. Thus, the offset angle remains constant for each specific motor at its rated RPM. This offset angle may vary between motors having the same ratings as a result of several manufacturing/design variations between specific motors. Again, with respect to an individual motor, the offset angle is selected by the present invention and maintained for that specific motor at its rated RPM. Variations in the RPM as a result of variable speeds permitted by the motor will result in the adaptive system of the present invention continuously selecting the proper offset angle for the newly selected RPM. The motor, operating at its selected RPM and under the monitoring of the embodiment incorporating the adaptive system of the present invention will require less total current than the same motor operating under a prior art system without the adaptive control.

The lookup table contains several addresses for each coil. Each address is an indication of the value of the current to be supplied to the coil at the moment that the address location is interrogated. The address at one position corresponds to the position of the rotor at that moment and provides an indication of the value of the current being delivered to its attached coil—and will thus cause the designated current to be supplied to the coil at that moment. When the next adjacent address is accessed, the current being delivered to the coil at that succeeding moment will be different than the preceding moment that had been addressed in the preceding address. A phase shifter is provided to modify the address and thus the current value to be delivered to the corresponding coil as these addresses are accessed.

The magnitude of the total current being supplied to the motor is determined as in the prior art by a feedback loop detecting the RPM of the motor to increase or decrease the RPM to achieve the desired or rated RPM. Thus, RPM is controlled by a typical feedback loop that senses RPM and controls total current being supplied to the motor to increase or decrease the current in accordance with the load requirements and maintain the rated or desired RPM. In the adaptive embodiment of the present invention, the system detects the total current being supplied to the motor and adjusts the offset phase angle through the phase shifter and memory lookup table to minimize the total current at the RPM—the latter being maintained by the speed control of the motor.

In another preferred embodiment, the offset angle that produces the most efficient operation at various RPMs (or linear speed in a linear system) may be predetermined and stored in a second lookup table or RPM lookup table. As the RPM of the motor changes and such changes are detected, the most efficient offset angle for the new RPM is selected from the RPM lookup table and implemented to provide the most efficient operation at the new RPM. Using stored angles is a useful alternative to the adaptive system when the motors being produced are identical and intended for use in identical or similar applications and environment. In the stored offset phase angle embodiment of the present invention, the RPM is detected and the predetermined offset phase angle for that RPM modifies the address in the memory lookup table being accessed at that moment to provide the correct current value for the connected stator winding.

### BRIEF DESCRIPTION OF THE DRAWINGS

The present invention may more readily be described by reference to the accompanying drawings in which:

FIG. 1 is an illustration of a simplified functional block diagram of a typical prior art permanent magnet direct current motor speed control.

FIG. 2 is a schematic representation of the stator and rotor of a typical PMDC motor configuration.

FIG. 3 is a functional block diagram of the PMDC motor control used in the system of the present invention.

FIG. 4 is a schematic representation of a plurality of groups of addresses of the memory lookup table utilized in the system of the present invention.

FIG. 5 is a schematic representation of a single group of addresses corresponding to a specific stator coil.

FIG. 6 is a schematic representation of a PMDC motor phase velocity curve showing the relationship of RPM to the electrical phase angle required to operate at maximum efficiency.

### DETAILED DESCRIPTION OF THE INVENTION

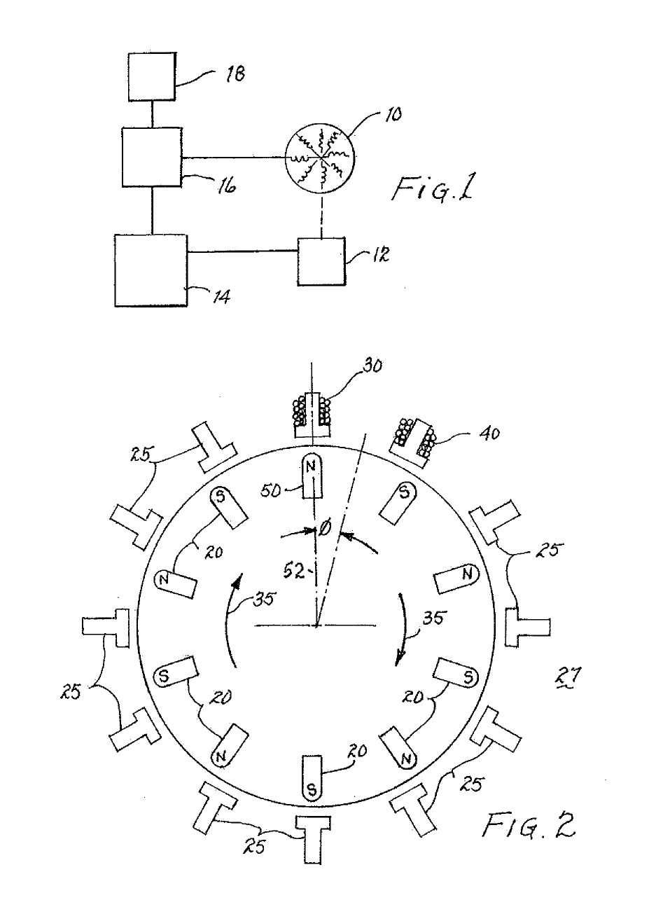

Referring to FIG. 1, a simplified functional block diagram of a typical prior art permanent magnet direct current motor speed control is shown. The controller system is intended to control the speed of the motor 10; a RPM or speed sensor 12 associated with the motor creates a feedback signal indicative of the motor's speed and provides a signal to a controller or a digital signal processor (DSP) 14. The DSP is connected to a current modulator 16 that adjusts the current provided by a power supply 18 and applies the adjusted current to the motor. In this manner, a desired RPM, such as the rated RPM, is achieved by the operating motor. Increases in load applied to the motor tend to slow the motor RPM; however, the speed sensor 12 detects this slowing tendency to provide an indication thereof to the DSP 14 which ultimately modifies the current being supplied to the motor by adjusting the current modulator 16. Thus, the chosen or rated RPM of the motor is maintained by increasing or decreasing the total current supplied to the motor as the load on the motor changes. The present invention includes this speed controlled feedback technique wherein variations in the load which would otherwise result in RPM changes are detected and compensated by the feedback loop which increases or decreases the total current being supplied to the motor. The present invention is directed to improving the efficiency of the motor operating under such controlled circumstances.

Referring to FIG. 2, a schematic representation of the stator and rotor of a typical PMDC motor configuration is shown. There are numerous motor configurations available; the schematic representation of FIG. 2 may be referred to as a 10-12 configuration. That is, ten permanent magnets 20 are secured to the rotor 23 and twelve stator coils 25 are uniformly positioned about the stator 27. Each stator coil includes a core supporting coil windings such as shown at 30 and 40, respectively. The coil windings have been omitted in the remainder of the cores for simplification; it will be understood that each of the cores is provided with a coil winding, and that excitation of the core windings by supplying current thereto creates an electromagnetic field, the flux of which extends across the gap between the stator and rotor and envelops the permanent magnets of the rotor that are in the vicinity of the electromagnetic field.

The coil windings of the respective cores are not interconnected as in the prior art in well known configurations such as a Y or delta arrangement; rather, each coil is independently connected to a current supply in a manner to be described. In the schematic representation of FIG. 2, the polarity of the respective permanent magnets is indicated and the direction of rotation of the rotor is shown by arrows 35. The strength of the electromagnetic field emanating from each coil will depend on the current being supplied to the coil at that moment; that is, the current may be increased, decreased, or may be reversed (by reversing current flow in the coil) to present a chosen electromagnetic field at any given moment.

When coils 30 and 40 are supplied current, the resulting electromagnetic fields of the two coils overlap or are superposed. Therefore, at any given point between the two coils there will be an attraction or repulsion of the permanent magnet attached to the rotor positioned in the superposed fields. The combined attraction of one coil and the repulsion of the adjacent coil creates a force acting upon the intervening permanent magnet traveling between the coils. This force acting upon the magnet, and therefore acting upon the rotor, causes motion of the magnet and rotor and creates torque and causes rotation about the rotor axis 42.

For purposes of illustration in describing the present system, the permanent magnet 50 is shown aligned directly beneath the coil 30 along a radial 52. Assuming that the rotor is rotating in the direction of the arrows 35, and recognizing that the electromagnetic fields of coils 30 and 40 are superposed, there is a position between the coils wherein the superposed electromagnetic fields of the coils exert the greatest force upon the magnet and thus upon the rotor. That is, as the rotor rotates, and the coils of the respective stator coils are supplied current to create electromagnetic fields, at any given RPM there is an offset angle φ measured from radial 52 at which maximum force is applied to the magnet. The creation of the superposed magnetic fields between coils may be manipulated so that at any given instance the force being exerted upon the rotor magnet is the maximum force possible. As the rotor rotates, the superposed electromagnetic fields also “rotate” to continuously present electromagnetic fields creating the greatest force on the corresponding magnet. It has been found that the angular position of the superposed fields that create the maximum force on the rotating magnet may be represented as an offset angle φ. That is, the excitation of the respective electromagnetic stator coils is modified by adjusting the current supplied to the respective coils to create this moving offset angle φ that continuously leads the rotor magnet. This offset angle φ is adjusted to maintain the maximum force on the rotating magnets as the rotor rotates. This maximum force, or maximum torque, resulting from the application of electromagnetic field energization is controlled by the system of the present invention by the appropriate modification of current being supplied to the individual coils synchronized with the positional information obtained by an encoder sensing the angular position of the rotor with respect to the stator. In a preferred embodiment of the present invention incorporating adaptive control, the instantaneous current being supplied to the individual coils is modified by sensing the total current being supplied to the motor; the system varies the offset angle φ until a minimum total current is being supplied to the motor. Under this latter condition, the motor is operating at its chosen or rated RPM and is operating at its minimum total current to maintain that

RPM. Increases in load to the motor may result in an attempt to reduce the RPM of the motor which is counteracted and controlled by the speed control technique described above and prevalent in prior art speed controller designs. Thus, an increase in the load may result in the requirement for additional total current being supplied to the motor to maintain the desired or rated RPM, but the adaptive system of the present invention will continue to adjust the apportionment, or ratio of the current supplied to the individual coils to maintain the offset angle φ and thus permit the motor to continue to operate under its new load conditions with a minimum total current required to maintain that RPM. The result of the implementation of the present invention is that the motor operates under any load and at any given RPM and at its greatest efficiency.

In the embodiment wherein the offset angles for various RPMs are predetermined and stored, upon detection of an RPM change, the appropriate offset angle for the newly selected RPM is accessed in an RPM table and implemented to provide an address modification to the lookup table to thus produce a current value for the attached stator winding that produces the greatest torque/efficiency for the motor at the new RPM.

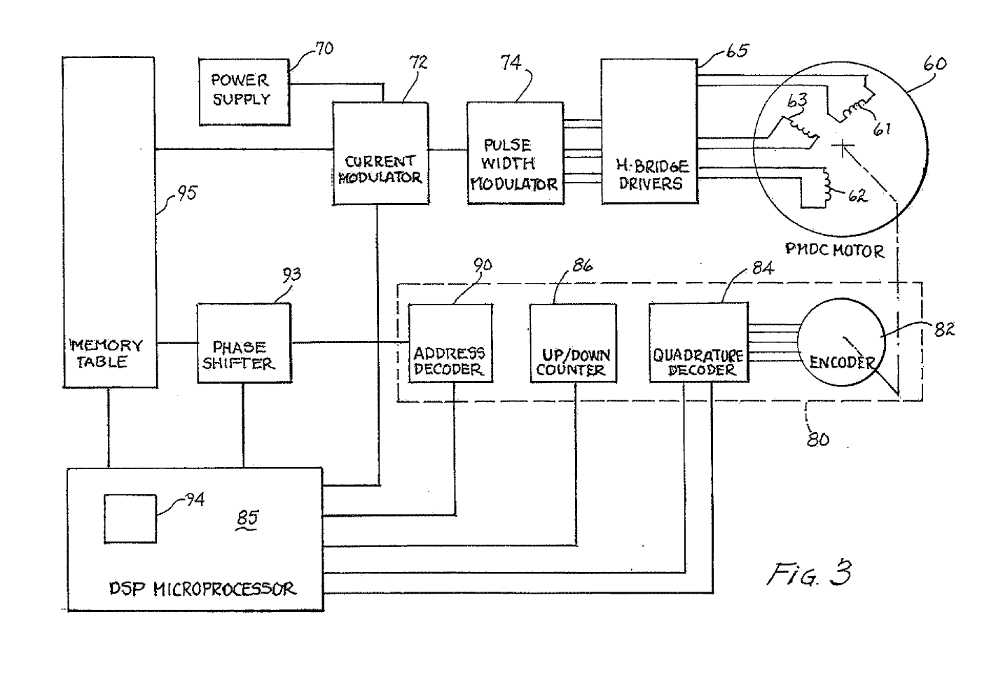

Referring to FIG. 3, a functional block diagram of a PMDC motor control incorporating the teachings of the present invention is shown. The permanent magnet direct current motor 60 is shown incorporating a plurality of windings 61-63. The windings are not connected in the conventional Y or delta configuration but are rather each individually driven by current supplied by an H-bridge driver 65 which supplies currents to the individual coils and reverses the current to the respective coils when required. H-bridge drivers are well known in the art and need not be described here. Current supplied to the H-bridge drivers 65 for delivery to the respective coils is derived from a power supply 70 whose current is modulated in a current modulator 72 and delivered via a pulse width modulator 74 to the H-bridge drivers. The power supply 70 may be any convenient source of DC current such as storage batteries or rectified AC power. Current modulation and pulse width modulation are well known in the art and will be recognized by those skilled in the art as conventional techniques for manipulating current and supplying current to a utilization device. A feedback loop 80 is provided and connected to the PMDC rotor to provide RPM and positional information of the rotor in a well known manner for utilization in the system. The speed or RPM information derived from the feedback loop 80 is received by a microprocessor 85 that controls the modulation of the total current being supplied from the power supply 70 to the motor to maintain a given or rated RPM in a manner described above in connection with the prior art.

Referring again to FIG. 3, the feedback loop 80 includes an encoder 82 that is secured to the armature shaft of the motor rotor and provides signals concerning rotor RPM and rotor rotation to a quadrature decoder 84. The quadrature decoder 84 receives signals from the encoder 82 and determines the rotational direction of the rotor—clockwise or counterclockwise. The information from the quadrature decoder 84 and the encoder 82 are provided to an up/down counter 86 that produces a count modulus corresponding to the number of electrical cycles of the motor. As indicated above, the PMDC motor may be typically formed in several configurations such as 2-3 or 8-12 or as described above 10-12. These numbers represent the number of magnets present on the rotor and the number of stator windings. Depending on the diameter of the motor and its specific torque requirements, the circuit configurations may be repeated many times about the motor. That is, each individual stator coil is provided with electrical current to generate its corresponding electromagnetic field; the energization of the coils are precisely controlled in relation to the positional information defining the position of the individual magnets. The information available from the up/down counter 86 thus provides a precise identification of the position of the rotor, and the position of the rotor magnets relative to the stator windings, at any given moment. An address decoder 90 receives the informational signals from the up/down counter 86 to produce an address corresponding to a specific stator coil.

A memory lookup table 95 is provided containing a plurality of groups of addresses, each group of addresses corresponding to a specific stator coil. Each address within the group of addresses corresponds to a current value to be supplied to the corresponding winding when that address is accessed. The values of the current values stored at each successive address within a group of addresses may be distributed in any particular waveform representation. That is, a typical example would be the successive current values stored in a given group of addresses forming a waveform such as a sine wave. Accessing successive addresses within the group of addresses would thus result in current values to be delivered to the corresponding winding forming a sine wave. Thus, such default values stored at each group of addresses may represent a sine wave or other waveforms. Thus, as the addresses within a group of addresses corresponding to a single coil are sequentially addressed, the instantaneous values of the current to be delivered to that coil are made available to the current modulator 72. Thus, as the rotor rotates, the current being delivered to each coil is modulated in accordance with the values stored at the addresses for that coil in the lookup table. The stored value of the current to be supplied to the individual windings is provided to the current modulator 72 that adjusts current from the power supply 70 at the moment that the address is accessed corresponding to the positional information and modifies the current being delivered at that moment to the specific winding. Thus, the total current supplied to the motor is apportioned to the individual coil each of which therefore receives a predetermined ratio of the total current at that moment.

The offset angle φ such as shown in FIG. 2 may represent a mechanical angle conveniently represented in the rotational environment of a motor; however, the angle φ may be represented as an electrical angle. For example, if the default values of the current amplitude being stored at the respective addresses in the memory lookup table are such that when the respective addresses are accessed in sequence the resulting represented current values present a sine wave, then the angle φ represents a phase shift angle, or offset angle, that may be utilized to modify the address of an inquiry to the lookup table. That is, if the positional information indicates that a particular address should be accessed in the lookup table 95, the address decoder 90 provides the address that is then modified by the phase shifter 93, under digital signal processor 85 control, by an offset phase shift angle φ resulting in the access of the next higher or lower address in the lookup table. The result of the implementation of the offset angle is the modification of the current value accessed at that time and applied through the current modulator 72 to the specific stator coil. In this manner, the current being supplied to each individual stator coil is modified to implement the modification in the corresponding electromagnetic fields and generate the maximum force, or torque, on the rotor under the influence of the superposed electromagnetic fields.

The total current being supplied to the motor 60 by the power supply 70 is thus distributed to the individual coils in accordance with the current values stored in the lookup table 95 corresponding to the respective individual coils 61-63. The total current is controlled, as in the prior art, to maintain a chosen or rated RPM; this total current is ratioed, or apportioned, and distributed to the respective individual coils; however, the system of the present invention provides a phase shifter 93 that also receives information from the address decoder 90, and instructions from the digital signal processor 85, and modifies the address being accessed to adjust the address by the offset angle φ. The value of the current stored at that modified address is then supplied to the current modulator 72 to thus adjust the current being supplied to that specific coil at the moment of access of the corresponding address.

As the rotor rotates, and successive addresses are accessed for each coil, the value stored in the lookup table provides information for the supply of the appropriate current level to each coil. In the adaptive embodiment of the present invention, as the rotor rotates, successive addresses are modified by the offset angle φ to maintain minimum total current while maintaining a given RPM at a given load.

Under microprocessor control, the current values for the respective coils are thus modified to reduce the total current being supplied by the power supply; the microprocessor through the phase shifter continues to modify the addresses by the offset angle and thus current values stored in the memory lookup table while monitoring motor RPM. As the load on the motor is increased, the RPM tends to lower and is detected by the speed control feedback loop resulting in an increase of the total current supplied to the motor under microprocessor control. At any new load situation, the adaptive system of the present invention continues to modify lookup table addresses until the minimum total current value is reached at that RPM. In this manner, the minimum total current necessary to maintain motor RPM under any given load conditions is maintained.

In the alternative embodiment wherein the angles, that produce the most efficient operation at various RPMs are stored, a second lookup table or RPM lookup table 94 is provided. In the alternative embodiment system, the RPM lookup table 94 provides the correct phase angle for any specific RPM without the need to monitor total current; this embodiment is appropriate when identical motors are being produced for specific applications and wherein slight manufacturing variations resulting in slight efficiency variations are tolerable.

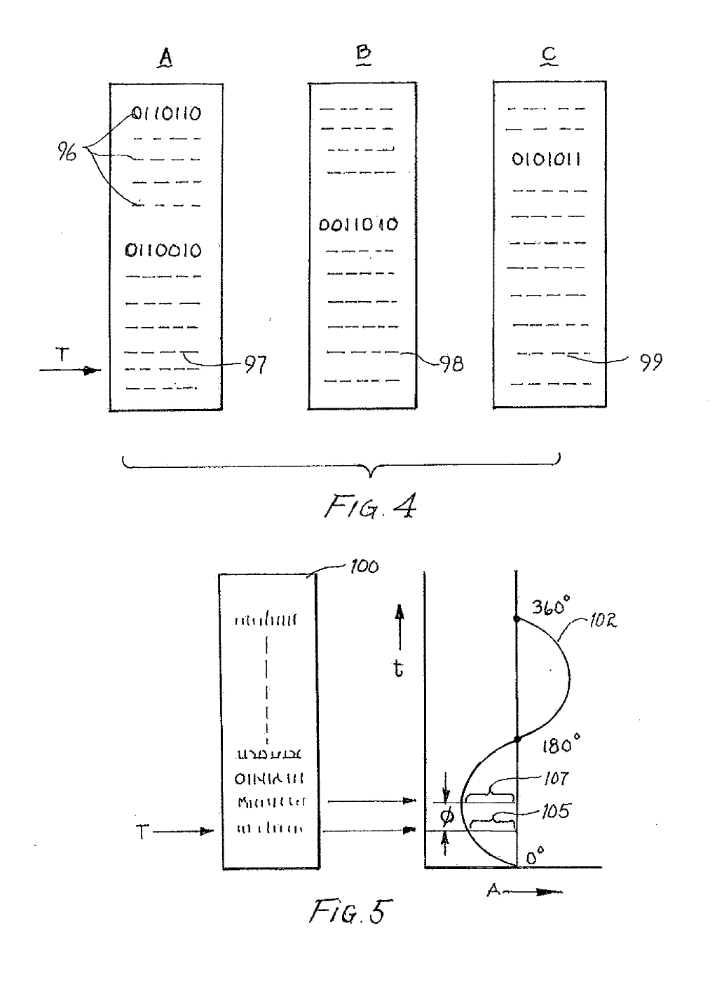

Referring to FIG. 4, a schematic representation of a plurality of groups of addresses of the memory lookup table 95 is shown. For purposes of illustration, three groups of addresses have been selected for description; each of the groups of addresses A, B and C correspond to a different respective stator coil. Each address 96 within each group of addresses represents the value of current to be supplied to the corresponding coil when that address is accessed. For example, at time T addresses 97, 98 and 99 are simultaneously accessed. Each address represents the value of the current to be supplied to the corresponding coil at time T. Thus, the electromagnetic field associated with each coil has a field strength corresponding to the current delivered to the coil; the permanent magnets that are in those respective fields are attracted/repulsed with a force to create torque. The values at each address within a group of addresses is accessed sequentially by the microprocessor control and modified by the phase shifter.

Referring to FIG. 5, a schematic representation of a single group of addresses 100 corresponding to a specific stator coil is shown. The distribution of current values stored in the lookup table, when sequentially accessed, conform to a predetermined wave shape such as a sine wave. However, the default distribution of address does not have to conform to a sine wave and may take other wave forms including some forms that may be discontinuous; that is, a predetermined wave form may include current values stored at a particular address equal to zero. Assuming that the default current values stored in the lookup table group conforms to a typical sine wave 102 the value of the current delivered to the corresponding coil at time T would normally have an amplitude 105; however, the system of the present invention employs the phase shifter 93 (FIG. 3) as described above that advances/retards the address wherein the current value being accessed at time T is indicated at 107. The difference in the current value is caused by the offset angle φ and results in the modification of the current being supplied to that winding, coordinated with modifications to the current being supplied to adjacent windings, to produce superposed electromagnetic fields of adjacent coils that creates the maximum torque at the chosen or rated RPM.

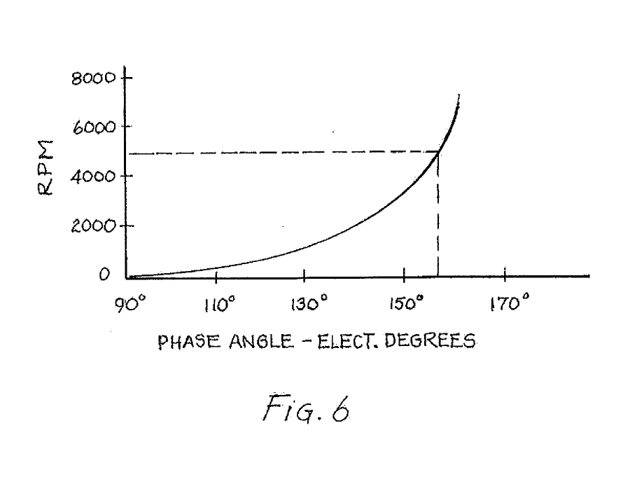

In the alternative embodiment wherein the electrical phase angle for most efficient operation at a chosen RPM is stored, reference may be had to FIG. 6. FIG. 6 is a schematic representation of the typical PMDC motor phase velocity curve showing the relationship of RPM to the electrical phase angle required to operate at maximum efficiency in the non-adaptive embodiment of the present invention wherein offset angles corresponding to RPM are stored. FIG. 6 is useful in the description of the derivation and application of the electrical phase angle at a given RPM to achieve maximum force/torque/efficiency at a specific RPM.

Referring to FIG. 6, a curve derived from a plot of RPM/electrical phase angle values is shown for use as permanent phase angles stored in the RPM lookup table 94 (FIG. 3) to be used with a PMDC to ensure maximum efficient at a variety of RPMs. The figure is shown incorporating a typical curve representing the respective electrical degrees phase angle associated with corresponding RPMs of a specific PMDC. As an example, a particular RPM (5,000) is chosen showing that at that RPM the electrical phase angle associated with the maximum efficiency of the PMDC is 158°. Thus, the address derived from the address decoder 90, modified by the phase shifter 93, presents an address to the lookup table corresponding to 158°. The value of the current stored at that address is thus the proper value to maintain maximum efficiency of the motor/load at that RPM.

As stated previously, the RPM lookup table 94 and the curve of FIG. 6 may be developed empirically and subsequently utilized for identical motors for use in identical or similar applications. Thus, the utilization of adaptive techniques described in connection with the first preferred embodiment, may not be necessary when the specific RPM/electrical phase angle is known for the development of maximum efficiency and the known and stored value of the offset phase angle can be used for a particular motor design used in a known environment and with a known load.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed:

1. A permanent magnet direct current motor control for use with a DC motor having a plurality of stator coils and a plurality of permanent magnets secured in a rotor wherein DC current is supplied to said stator coils to create electromagnetic fields to attract/repel said permanent magnets to cause movement of said rotor, the improvement comprising:
(a) a memory lookup table having a plurality of groups of addresses, each group of addresses corresponding to a different one of said stator coils, respectively;
(b) each address storing data representing the value of current to be delivered, when the address is accessed, to the corresponding stator coil;
(c) an encoder for providing signals indicating the position of the rotor relative to the stator;
(d) a digital signal processor connected to said encoder and said memory lookup table for successively accessing the addresses;
(e) a phase shifter connected to said digital signal processor and to said memory lookup table for modifying each address as the addresses are accessed; and
(f) a current modulator connected to said memory lookup table to receive said value from said memory and provide current to said coils corresponding to said value.

2. The permanent magnet direct current control of Claim I wherein the data stored in successive addresses within each group of addresses represents a predetermined waveform.

3. The permanent magnet direct current control of claim 2 wherein said waveform is a sine wave.

4. A permanent magnet direct current motor control for use with a DC motor having a plurality of stator coils and a plurality of permanent magnets secured in a rotor wherein DC current is supplied to said stator coils to create electromagnetic fields to attract/repel said permanent magnets to cause movement of said rotor, the improvement comprising:
(a) a memory lookup table having a plurality of groups of addresses, each group of addresses corresponding to a different one of said stator coils, respectively, each address storing data representing the value of current to be delivered, when the address is accessed, to the corresponding stator coil;
(b) a feedback loop including;
i. an encoder connected to said rotor for providing signals indicating the position of the rotor relative to the stator;
ii. a quadrature decoder connected to said encoder for determining the rotational direction of the rotor;
iii. an up down counter to produce a count of the number of electrical cycles of the motor; and
iv. an address decoder connected to said up down counter to produce an address corresponding to a specific stator coil;
(c) a phase shifter connected to said address decoder and to said memory lookup table for modifying each address as the addresses are received from the address decoder;
(d) a digital signal processor connected to said feedback loop and said phase shifter for instructing said phase shifter to modify addresses the phase shifter receives from the address decoder; and
(e) a current modulator connected to said memory lookup table to receive said value from said memory and provide current to said coils corresponding to said value.

5. The permanent magnet direct current motor control of claim 4 wherein the data stored in successive addresses within each group of addresses represents a predetermined waveform.

6. The permanent magnet direct current motor control of claim 5 wherein said waveform is a sine wave.

7. A permanent magnet direct current motor control for use with a DC motor having a plurality of stator coils and a plurality of permanent magnets secured in a rotor wherein DC current is supplied to said stator coils to create electromagnetic fields to attract/repel said permanent magnets to cause movement of said rotor, the improvement comprising:
(a) a memory lookup table having a plurality of groups of addresses, each group of addresses corresponding to a different one of said stator coils, respectively, each address storing data representing the value of current to be delivered, when the address is accessed, to the corresponding stator coil;
(b) a feedback loop including;
i. an encoder connected to said rotor for providing signals indicating the position of the rotor relative to the stator;
ii. a quadrature decoder connected to said encoder for determining the rotational direction of the rotor;
iii. an up down counter to produce a count of the number of electrical cycles of the motor; and
iv. an address decoder connected to said up down counter to produce an address corresponding to a specific stator coil;
(c) a phase shifter connected to said address decoder and to said memory lookup table for modifying each address as the addresses are received from the address decoder;
(d) a digital signal processor connected to said feedback loop and said phase shifter for instructing said phase shifter to modify addresses the phase shifter receives from the address decoder to maintain minimum total current supplied to the motor under a given load at a given RPM; and
(e) a current modulator connected to said memory lookup table to receive said value from said memory and provide current to said coils corresponding to said value.

8. A permanent magnet direct current motor control for use with a DC motor having a plurality of stator coils and a plurality of permanent magnets secured in a rotor wherein DC current is supplied to said stator coils to create electromagnetic fields to attract/repel said permanent magnets to cause movement of said rotor, the improvement comprising:
(a) a memory lookup table having a plurality of groups of addresses, each group of addresses corresponding to a different one of said stator coils, respectively;
(b) each address storing data representing the value of current to be delivered, when the address is accessed, to the corresponding stator coil;
(c) an encoder connected to said rotor for providing signals indicating the position of the rotor relative to the stator;
(d) an address decoder connected to said encoder for providing addresses in said memory lookup table;
(e) an RPM lookup table storing a plurality of phase shift angles each corresponding to a given RPM;
(f) a digital signal processor connected to said encoder and to said memory lookup table and RPM table for successively accessing the addresses;
(g) a phase shifter connected to said address decoder, to said digital signal processor and to said memory lookup table for modifying each address as the addresses are accessed, the addresses modified in accordance with the stored phase shift angle in the RPM lookup table corresponding to the motor RPM; and
(h) a current modulator connected to said memory lookup table to receive said value from said memory and provide current to said coils corresponding to said value.
